(19) United States
(12) Patent Application Publication
(10) Pub. No.: US 2007/0031561 A1
(43) Pub. Date: Feb. 8, 2007

(54) Mouth-moistening compositions, delivery systems containing same and methods of making same

(75) Inventors: Jamileh Lakkis, Morris Plains, NJ (US); Dorothy Euan, New York, NY (US); Susan Pettigrew, Suffern, NY (US); Diane Bugge, Rockaway, NJ (US)

Correspondence Address: HOFFMANN & BARON, LLP, 6900 JERICHO TURNPIKE, SYOSSET, NY, 11791, US

(73) Assignee: Cadbury Adams USA LLC.

(21) Appl. No.: 11/503,439

(22) Filed: Aug. 11, 2006

Related U.S. Application Data
(60) Provisional application No. 60/707,759, filed on Aug. 12, 2005.

(51) Int. Cl. A23L 1/236

(52) U.S. Cl. 426/548

(57) ABSTRACT

The present invention relates to compositions and comestibles that impart a mouth-moistening effect when orally consumed by an individual. More specifically, the compositions of the present invention may include a blend of components, such as a sweetening composition, food-grade acid composition and a cooling agent, that reduces or eliminates the perception of mouth dryness in an individual. The present invention also provides methods for preparing such comestibles, as well as methods of treating xerostomia by orally administering such comestibles.

### CROSS-REFERENCE TO RELATED APPLICATIONS

This application claims the benefit of U.S. Provisional Application No. 60/707,759, filed Aug. 12, 2005, the contents of which are incorporated herein by reference.

### FIELD

The present invention includes compositions and comestibles that impart a mouth-moistening effect when orally consumed by an individual. The present invention also provides methods for preparing such comestibles and methods of treating xerostomia by administering such comestibles.

### BACKGROUND

Many individuals suffer from dry mouth, occasionally referred to as “xerostomia,” from time to time due to a variety of physiological and environmental factors. Dry mouth may be caused by reduced levels of saliva and can feel sticky and uncomfortable. Dry mouth may lead to difficulties in tasting, chewing, swallowing and speaking, as well as a variety of more serious medical conditions. Prescription medications and artificial saliva are available for severe cases of dry mouth. Individuals experiencing moderate levels of mouth dryness, however, often desire consumables that provide a sensation of hydration or mouth-moistening. Although water is often sought for relief of mouth dryness, it is not always convenient or portable, and it does not provide long-lasting relief.

There is a need, therefore, for comestibles, particularly confectioneries, which provide a sensation of mouth moistening upon consumption, which are portable, such that they may be consumed whenever a feeling of dry mouth is experienced by an individual. Further, there is a need for methods of preparing such comestibles and methods of treating xerostomia or other dry mouth conditions by administering same.

### SUMMARY

In some embodiments there is provided a comestible including: a composition including a blend of a sweetening composition which contains sugar and a sweetness reducing agent, a food-grade acid composition and optionally a cooling agent; a flavor agent; and optionally a carrier.

Some embodiments provide a comestible including: a composition which includes a blend of a sweetening composition containing sugar and a sweetness reducing agent, a food-grade acid composition and optionally a cooling agent; a flavor agent; and optionally a carrier. The comestible has a mouth dryness elimination intensity of at least about 3.6 on a scale of 1-5.

In some embodiments, there is provided a comestible including: a composition containing a homogenous blend of a sweetening composition which includes sugar and isomalt alone or in combination with maltitol, a food-grade acid composition which includes malic acid present in amounts of about 2.5% to about 5% by weight of the comestible and a cooling agent present in amounts of about 0.03% to about 0.2% by weight of the comestible; a flavor agent; and optionally a carrier.

In some embodiments, there is provided a composition including a blend of: a sweetening composition which includes sugar and a sweetness reducing agent; a food-grade acid composition which includes malic acid; and optionally a cooling agent. The composition has a mouth dryness elimination intensity of at least about 3.6 on a scale of 1-5.

Some embodiments provide a comestible including: a composition which includes a blend of a sweetening composition containing sugar and a sweetness reducing agent, a food-grade acid composition and optionally a cooling agent; a flavor agent; and optionally a carrier. The comestible has a refreshment intensity of at least about 3.4 on a scale of 1-5.

Some embodiments provide a comestible including: a composition containing a blend of a sweetening composition which includes sugar and a sweetness reducing agent, a food-grade acid composition and optionally a cooling agent; a flavor agent; and optionally a carrier. The comestible has a mouth-watering effect of at least about 7 on a scale of 1-9.

In some embodiments there is provided a composition which includes a blend of: a food-grade acid composition including malic acid; a cooling agent; and a sweetening composition which includes about 95% to about 99.95% sugar by weight of the sweetening composition and about 0.05% to about 5% sweetness reducing agent by weight of the sweetening composition.

In some embodiments there is provided a composition including: a cooked amorphous matrix containing sugar and a sweetness reducing agent; a food-grade acid composition which includes malic acid; and a cooling agent.

In some embodiments there is provided a pre-mix including: a homogenous dry blend of sugar and a sweetness reducing agent; a food-grade acid composition which includes malic acid; and a cooling agent.

Some embodiments provide a dividable candy mass which includes: a composition containing a blend of a sweetening composition including sugar and a sweetness reducing agent, a food-grade acid composition including malic acid alone or in combination with one or more acids selected from acetic acid, adipic acid, ascorbic acid, butyric acid, citric acid, formic acid, fumaric acid, glyconic acid, lactic acid, phosphoric acid, oxalic acid, succinic acid, tartaric acid, and combinations thereof, and a cooling agent; a flavor agent; and optionally a carrier.

In some embodiments there is provided a candy mass including: a composition which includes a molded blend of a sweetening composition which includes sugar and a sweetness reducing agent, a food-grade acid composition which includes malic acid alone or in combination with one or more acids selected from acetic acid, adipic acid, ascorbic acid, butyric acid, citric acid, formic acid, fumaric acid, glyconic acid, lactic acid, phosphoric acid, oxalic acid, succinic acid, tartaric acid, and combinations thereof, and a cooling agent; a flavor agent; and optionally a carrier.

Some embodiments provide a chewable comestible including: a chewable carrier selected from water-soluble chewable bases, water insoluble chewable bases and combinations thereof; a composition which includes a blend of a sweetening composition containing sugar and a sweetness reducing agent, a food-grade acid composition including malic acid, and a cooling agent; and a flavor agent.

Some embodiments provide a method of improving the mouth-watering effect of a comestible, including the steps of: providing a comestible composition which contains a blend of a food-grade acid composition which includes malic acid alone or in combination with one or more acids selected from acetic acid, adipic acid, ascorbic acid, butyric acid, citric acid, formic acid, fumaric acid, glyconic acid, lactic acid, phosphoric acid, oxalic acid, succinic acid, tartaric acid, and combinations thereof, and a sweetening composition containing sugar; and reducing the sweetness of the comestible composition by adding a sweetness reducing agent, wherein the sweetness reducing agent is about 0.05% to about 5% by weight of the sweetening composition.

Some embodiments provide a method of preparing a comestible, including the steps of: heating a sweetening composition which includes sugar and a sweetness reducing agent and a solvent to a temperature of about 135° C. to about 160° C.; adding to the heated sweetening composition a food-grade acid composition which includes malic acid alone or in combination with one or more acids selected from acetic acid, adipic acid, ascorbic acid, butyric acid, citric acid, formic acid, fumaric acid, glyconic acid, lactic acid, phosphoric acid, oxalic acid, succinic acid, tartaric acid, and combinations thereof, optionally a cooling agent and a flavor agent; and forming a comestible from the combination of components.

Some embodiments provide a method of treating xerostomia, including the steps of: (a) providing a comestible which includes: a composition containing a blend of a sweetening composition including sugar and a sweetness reducing agent, a food-grade acid composition including malic acid and optionally a cooling agent; a flavor agent; and optionally a carrier; (b) applying the comestible into the oral cavity of an individual; and (c) allowing the comestible to dissolve and release the composition of step (a) from the comestible into the oral cavity, thereby reducing the mouth dryness of the individual.

Some embodiments provide a center-fill confectionery composition including: (a) a center-fill region; and (b) a confectionery region surrounding the center-fill region, where the confectionery region includes a carrier, and where at least one of the regions includes a mouth-moistening composition containing (i) a sweetening composition including sugar and a sweetness reducing agent and (ii) a food-grade acid composition.

In some embodiments there is provided a comestible including: (a) a composition which includes a blend of: (i) a sweetening composition including at least one non-sucrose saccharide, where the sweetening composition has a sweetness intensity less than the sweetness intensity of sucrose; (ii) a food-grade acid composition; and (iii) optionally a cooling agent; (b) a flavor agent; and (c) optionally a carrier.

### BRIEF DESCRIPTION OF THE DRAWINGS

FIG. 1 is a graphical representation of the interaction of various flavors with the food-grade acid composition.

FIG. 2a is a graphical representation of mouth dryness elimination intensity ratings of comestibles containing no sweetness reducing agent and varying levels of food-grade acid and cooling agent.

FIG. 2b is a graphical representation of mouth dryness elimination intensity ratings of comestibles containing about 5% by weight sweetness reducing agent and varying levels of food-grade acid and cooling agent.

FIG. 2c is a graphical representation of mouth dryness elimination intensity ratings of comestibles containing about 10% by weight sweetness reducing agent and varying levels of food-grade acid and cooling agent.

FIG. 3a is a graphical representation of refreshment intensity ratings of comestibles containing about 10% by weight sweetness reducing agent and varying levels of food-grade acid and cooling agent.

FIG. 3b is a graphical representation of refreshment intensity ratings of comestibles containing about 5% by weight sweetness reducing agent and varying levels of food-grade acid and cooling agent.

FIG. 3c is a graphical representation of refreshment intensity ratings of comestibles containing no sweetness reducing agent and varying levels of food-grade acid and cooling agent.

FIG. 4a is a graphical representation of mouth-watering effect of comestibles containing no sweetness reducing agent and varying levels of food-grade acid and cooling agent.

FIG. 4b is a graphical representation of mouth-watering effect of comestibles containing about 5% by weight sweetness reducing agent and varying levels of food-grade acid and cooling agent.

FIG. 4c is a graphical representation of mouth-watering effect of comestibles containing about 10% by weight sweetness reducing agent and varying levels of food-grade acid and cooling agent.

### DETAILED DESCRIPTION

As will be described in detail herein, some embodiments provide compositions and comestibles, such as confectioneries, that impart a sensation of mouth moistening upon consumption by an individual, thereby relieving a feeling of dry mouth. To relieve mouth dryness, the compositions and comestibles may provide a combination of attributes that contribute to an overall sensation of mouth moistening, including a low level of sweetness, slight sourness, which stimulates salivation, and/or long-lasting cooling or refreshment. Other factors, such as flavor, texture, shape, and smoothness of the compositions and comestibles also may contribute to the sensation of mouth-moistening.

As used herein the transitional term “comprising,” (also “comprises,” etc.) which is synonymous with “including,” “containing,” or “characterized by,” is inclusive or open-ended and does not exclude additional, unrecited elements or method steps, regardless of its use in the preamble or the body of a claim.

As used herein, the terms “bubble gum” and “chewing gum” are used interchangeably and are both meant to include any gum compositions.

The term “food-grade acid,” as used herein, encompasses any acid that is acceptable for use in edible compositions.

Mouth-Moistening Compositions

Embodiments described herein provide an oral composition that imparts mouth-moistening perception to an individual upon consumption. The compositions may thereby alleviate the feeling of dry mouth that is associated with a variety of physiological and environmental factors.

In some embodiments, the compositions may include a blend of components that contribute to the overall mouth-moistening effect. More specifically, in some embodiments, the compositions may include a sweetening composition, which contains a sugar sweetener and a sweetness reducing agent, and a food-grade acid composition. Such blend of components may provide low sweetness and slight sourness, which together contribute to a sensory perception of mouth moistening. In some embodiments, a sweetening composition does not include sugar but includes at least one, or a blend, of saccharides, where the blend has a sweetness intensity that is less than sucrose. In some embodiments, the compositions also may include a cooling agent or combination of cooling agents. Incorporation of cooling agents may provide an additional desirable characteristic of long-lasting refreshment. Such refreshment may contribute to the overall perception of mouth-moistening.

As described above, the compositions may include a blend of components that impart a perception of mouth-moistening. The term “blend” refers to a mix, or combination of components into an integrated whole. In some instances, the separate components or line of demarcation cannot be distinguished. Some embodiments further may include a homogenous blend of the components. The term “homogenous” refers to a uniform blend of the components.

Further, as used herein, the term “mouth-moistening” refers to an oral sensation of hydration, which may involve increased salivation, perceived by an individual during and following consumption of the compositions described herein. The oral sensation of hydration also may refer to a reduced perception of dryness or stickiness in the mouth.

As mentioned above, some embodiments include a blend of a sweetening composition and a food-grade acid composition. The sweetening composition may include one or more sugar sweeteners and one or more sweetness reducing agents. In some embodiments, the sweetening composition may include a blend or pre-mix of a sugar sweetener and one or more sweetening reducing agents. The sweetness reducing agent lowers the level of sweetness as compared to sugar alone. For example, the sweetness reducing agent may be a component that inhibits the sweet perception of sugar, a component that replaces some of the sugar and effectively reduces the overall sweet perception of sugar or a combination of such components. Reduced levels of sweetness contribute to the sensation of mouth-moistening perceived by the individual user.

In other embodiments, the sweetening composition may include a sweetness reducing agent alone. In some sugarless, or sugar-free, embodiments, the sweetening composition may include at least one non-sucrose saccharide. Some embodiments may include a plurality of non-sucrose saccharides. For example, the sweetening composition may include sugarless sweetening agents, such as polyols. Suitable polyols include, but are not limited to, sorbitol, mannitol, maltitol, isomalt, polydextrose, xylitol, erythritol, lactitol, galactitol, hydrogenated starch hydrolysates, polyglycitol syrups, and combinations thereof. In such embodiments, the sweetening composition desirably has a sweetness intensity less than the sweetness intensity of sucrose.

Suitable sugar sweeteners for use in the compositions generally include mono-saccharides, di-saccharides and poly-saccharides such as but not limited to, sucrose (sugar), dextrose, maltose, dextrin, xylose, ribose, glucose, mannose, galactose, fructose (levulose), lactose, invert sugar, fructo oligo saccharide syrups, partially hydrolyzed starch, corn syrup solids and mixtures thereof.

Sweetness reducing agents may include a component that lowers the level of sweetness below the level of a sugar sweetener alone. Suitable sweetness reducing agents include, but are not limited to, sweetness inhibiting agents or sweetness receptor blockers, sugarless sweetening agents, non-sucrose saccharides, proteins, glycoproteins, oligoproteins, polyols, glycerol, fats, waxes and mixtures thereof.

Sweetness inhibiting agents or receptor blockers generally act to inhibit the sweet taste perceived in compositions into which they are incorporated. Suitable sweetness inhibitors include, but are not limited to: ethers or thioethers of acetic acid derivatives, as disclosed in U.S. Pat. No. 4,567,053; salts of substituted benzoylalkyl carboxylic acids, as disclosed in U.S. Pat. No. 4,544,565; 3-aminobenzenesulfonic acid and derivatives thereof, as disclosed in U.S. Pat. No. 4,642,240; substituted phenylalkyl carboxylic acid salts and substituted phenyl ketoalkyl carboxylic acid salts, as disclosed in U.S. Pat. No. 4,567,053; substituted benzoyloxy acetic and 2-propionic acid salt derivatives, as disclosed in United Kingdom Patent Application No. 2,180,534; 2-p-methoxyphenoxypropionic acid (commercially available as LACTISOLE from Tate & Lyle); p-methoxybenzylacetic acid; and mixtures thereof. These sweetness inhibitors are described in more detail in the following U.S. patents, each of which is incorporated by reference herein in its entirety: U.S. Pat. No. 5,021,249 to Bunick et al.; U.S. Pat. No. 4,567,053 to Lindley; U.S. Pat. No. 4,544,565 to Barnett; and U.S. Pat. No. 4,642,240 to Barnett et al.

Suitable sugarless sweetening agents used as sweetness reducing agents include sugar alcohols (or polyols) such as, but not limited to, sorbitol, xylitol, mannitol, galactitol, maltitol, hydrogenated isomaltulose (isomalt), lactitol, erythritol, hydrogenated starch hydrolysate, stevia and mixtures thereof.

In some embodiments, the sugarless sweetening agent includes isomalt (PALATINIT™) alone or in combination with maltitol.

Suitable hydrogenated starch hydrolysates include those disclosed in U.S. Pat. No. 4,279,931 and various hydrogenated glucose syrups and/or powders which contain sorbitol, maltitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN®, a commercially available product manufactured by Roquette Freres of France, and HYSTAR®, a commercially available product manufactured by SPI Polyols, Inc. of New Castle, Del., are also useful.

Non-sucrose saccharides also may be employed as sweetness reducing agents. In some sugarless embodiments, as described above, the sweetening composition may include at least one non-sucrose saccharide, without sugar. Non-sucrose saccharides include mono-saccharides, di-saccharides, oligo-saccharides and polysaccharides. Suitable examples of non-sucrose saccharides include, but are not limited to: starches, both modified and natural, and starch fractions including amylose and amylopectin; pectins, such as low and high molecular weight methoxy pectins; alginates, such as sodium and potassium; natural and synthetic gums, such as gum arabic, gellan gum, welan gum, gum tragacanth, xanthan gum, guar gum, and locust bean gum; celluloses, such as carboxymethyl cellulose, hydroxypropyl cellulose, hydroxymethyl cellulose, hydroxybutyl carboxymethyl cellulose, hydroxypropylethyl cellulose and methylethyl cellulose; carrageenans, such as alpha-, gamma-, iota-, kappa- and lambda carrageenans; polyols; and combinations thereof.

Useful proteins for use as sweetness reducing agents may be selected from a wide variety of materials. Suitable proteins include, for example: gelatin; caseins and caseinates; whey proteins; soy proteins; wheat proteins; corn proteins; rice proteins; barley proteins; egg proteins; muscle proteins; proteins from other legumes and tubers; and combinations thereof. Glycoproteins include, for example, chondroitins, glucosaminoglycans and lectins. Glycolipids also may be employed.

Fats for use as sweetness reducing agents include both saturated and unsaturated fats. Waxes include, for example, bees wax, carnauba wax, low melting paraffins, shellac, candelilla wax, microcrystalline and synthetic waxes.

Combinations of various sweetness reducing agents also may be employed in some embodiments.

In some embodiments, the sweetness reducing agent may be present in amounts of about 0.01% to about 80% by weight of the mouth-moistening composition, more specifically in amounts of about 3% to about 55% by weight. The sweetening composition, i.e., sweetness reducing agents in combination with sugar sweeteners in some embodiments, or sweetness reducing agents alone in other embodiments, may be present in amounts of about 0.01% to about 99% by weight of the composition.

In accordance with some embodiments, the ratio of sugar sweetener to sweetness reducing agent is 99.95% to 0.05%, more desirably 95.0% to 5.0% within the sweetening composition.

The mouth-moistening compositions may include a food-grade acid composition, which lends sourness to the compositions. Food-grade acids stimulate the salivary glands to produce more saliva. The food-grade acid composition may include one or more acids having a pKa of about 1 to about 5. In some embodiments, it is desirable to use malic acid in the food-grade acid composition. Other suitable food-grade acids include, but are not limited to: acetic acid; adipic acid; ascorbic acid; butyric acid; citric acid; formic acid; fumaric acid; glyconic acid; lactic acid; phosphoric acid; oxalic acid; succinic acid; tartaric acid; and combinations thereof. Such food-grade acids may be used alone or in combination with malic acid.

The food-grade acid composition may be present in amounts of about 15% to about 90% by weight of the mouth-moistening composition. In some embodiments, the food-grade acid composition may be present in amounts of about 20% to about 50% by weight.

Some embodiments also may include a cooling agent or combination of cooling agents. A variety of well-known cooling agents may be employed in the oral compositions. For example, among the useful cooling agents are included xylitol, erythritol, dextrose, sorbitol, menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide (WS-23), N-ethyl-p-menthane-3-carboxamide (WS-3), isopulegol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, tradename FRESCOLAT® type MGA); 3-1-menthoxypropane-1,2-diol (from Takasago, FEMA 3784); and menthyl lactate; (from Haarman & Reimer, FEMA 3748, tradename FRESCOLAT® type ML), WS-30, WS-14, Eucalyptus extract (p-Mehtha-3,8-Diol), cineol, Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopryl-bicyclo(2.2.1), Heptane-2-carboxamide; and Menthol methyl ether, and menthyl pyrrolidone carboxylate among others. These and other suitable cooling agents are further described in the following U.S. patents, all of which are incorporated in their entirety by reference hereto: U.S. Pat. Nos. 4,230,688; 4,032,661; 4,459,425; 4,136,163; 5,266,592; 6,627,233.

In some embodiments, the mouth-moistening composition may include a combination of cooling agents, such as, for example, WS-23 and other suitable cooling agents.

Cooling agents may be present in amounts of about 0.01% to about 10% by weight of the mouth-moistening composition. In some embodiments, cooling agents may be present in amounts of about 0.05% to about 3.00% by weight.

In some embodiments, the mouth-moistening composition also may include optional additives such as flavor agents (flavors, flavorings), coloring agents (colorants, colorings), and the like, and mixtures thereof.

Delivery Systems

Some embodiments provide delivery systems or delivery vehicles for the mouth-moistening compositions described above. The delivery systems (also referred to as “comestibles”) generally encompass any edible or consumable compositions, such as foods and beverages. More particularly, the comestible may be selected from forms such as, but not limited to, hard candy, soft candy, cotton candy, center-filled candy, pressed tablets, chewing gum, center-filled chewing gum, film, lozenges, liquid beverages, powdered beverages, and the like. Such comestibles may include a mouth-moistening composition, a flavor agent and optionally a carrier.

As described in detail above, the mouth-moistening composition includes a blend of a sweetening composition, which may contain a sugar sweetener and a sweetness reducing agent, a food-grade acid composition and optionally a cooling agent. Also as described above, in some other embodiments, the mouth-moistening composition includes a blend of a sweetening composition, which may be sugarless and contains a sweetness reducing agent, a food-grade acid composition and optionally a cooling agent.

The sweetening composition may include components as described above. In general, the sweetening composition is present in amounts of about 0.05% up to 99.5% by weight of the comestible. In some embodiments, the sweetening composition is present in amounts of about 1% to about 10% by weight.

The food-grade acid composition also includes components as described above. In general, the food-grade acid composition is present in amounts of about 0.01% to about 20% by weight of the comestible. In some embodiments, the food-grade acid composition is present in amounts of about 0.5% to about 5% by weight, more specifically about 2.5% to about 5% by weight.

In some embodiments, the food-grade acid composition includes malic acid. Malic acid may be present in amounts sufficient to produce a mouth-moistening perception immediately upon consumption, throughout the chewing period and for a period of time after the comestible is consumed. For example, the mouth moistening perception may last from about 1 minute to several minutes after the comestible is substantially consumed. In some embodiments, these mouth-moistening durations may be achieved by a combination of food-grade acids, such as citric and malic acid or a blend of malic and one or more other food-grade acids. Accordingly, malic acid, alone or in combination with other food-grade acids, may be present in amounts of about 0.01% to about 20% by weight of the comestible, more specifically about 0.5% to about 5% by weight, and even more specifically about 2.5% to about 5% by weight.

As described above, some embodiments also may include a cooling agent or combination of cooling agents in the mouth-moistening composition. In such embodiments, the cooling agent(s) is present in amounts of about 0.001% to about 1.5% by weight of the comestible. In some embodiments, the cooling agent(s) is present in amounts of about 0.03% to about 0.2% by weight.

In some embodiments, it may be desirable to provide a comestible that is substantially free of menthol. Menthol may cause a sensation of astringency or puckering upon consumption, particularly at high levels, which has a negative impact on hydration. As such, some embodiments are free or at least substantially free of menthol. The term “substantially free” refers to less than about 0.55% menthol by weight of the comestible, more specifically less than about 0.001% menthol by weight.

The comestible also may include a flavor agent. The flavoring agents which may be used include those flavors known to the skilled artisan, such as natural and artificial flavors. These flavorings may be chosen from synthetic flavor oils and flavoring aromatics and/or oils, oleoresins and extracts derived from plants, leaves, flowers, fruits, and so forth, and combinations thereof. Nonlimiting representative flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Also useful flavorings are artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavors include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with cooling agents.

Other useful flavorings include aldehydes and esters such as cinnamyl acetate, cinnamaldehyde, citral diethylacetal, dihydrocarvyl acetate, eugenyl formate, p-methylamisol, and so forth may be used. Generally any flavoring or food additive such as those described in Chemicals Used in Food Processing, publication 1274, pages 63-258, by the National Academy of Sciences, may be used. This publication is incorporated herein by reference.

Further examples of aldehyde flavorings include but are not limited to acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), cherry, grape, strawberry shortcake, and mixtures thereof.

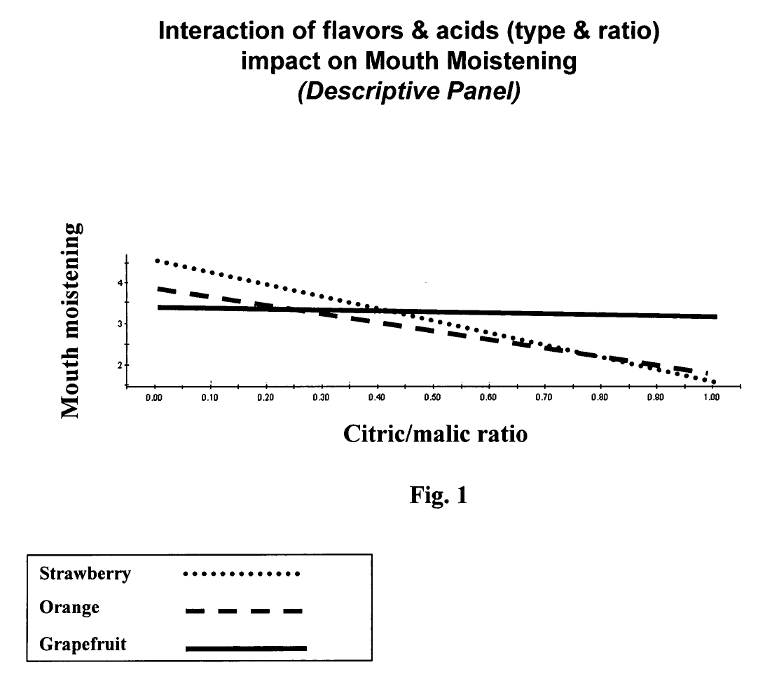

Some flavors may specifically contribute to the perception of mouth-moistening, such as, for example, citrus flavors, including orange, grapefruit and lemon, strawberry, tropical, honey, honey/lemon, blueberry and mint. In some embodiments, the flavor may interact with the food-grade acid composition to provide a higher intensity of mouth-moistening than other flavors. For instance, the food-grade acid composition of some embodiments includes malic acid alone or in combination with citric acid. As the level of malic acid in the compositions is increased as compared to citric acid, the intensity of the mouth-moistening perception increases for strawberry and orange flavors, whereas it remains constant for grapefruit flavor. FIG. 1 provides a representation of this interaction.

In some embodiments, the flavor agent may be employed in either liquid form and/or dried form. When employed in the latter form, suitable drying means such as spray drying the oil may be used. Alternatively, the flavor agent may be absorbed onto water soluble materials, such as cellulose, starch, sugar, maltodextrin, gum arabic and so forth or may be encapsulated. The actual techniques for preparing such dried forms are well-known.

In some embodiments, the flavor agents may be used in many distinct physical forms well-known in the art to provide an initial burst of flavor and/or a prolonged sensation of flavor. Without being limited thereto, such physical forms include free forms, such as spray dried, powdered, beaded forms, encapsulated forms, and mixtures thereof.

The amount of flavor agent employed herein may be a matter of preference subject to such factors as the type of final comestible, such as a candy composition or chewing gum composition; the individual flavor; the carrier employed; and the strength of flavor desired. Thus, the amount of flavoring may be varied in order to obtain the result desired in the final product.

In general, the flavor agent is present in amounts of about 0.02% to about 5%, and more specifically from about 0.05% to about 3%, and even more specifically, from about 0.50% to about 1.8%, by weight of the comestible.

In addition, the comestible optionally includes a carrier. In some embodiments, the sweetening composition itself may act as the carrier for the comestible. For example, sweetening compositions including a sugar and/or a sugarless sweetening agent may act as a carrier in hard candy embodiments. Some embodiments, however, may include a carrier in addition to the sweetening composition. The carrier may be selected from a variety of well-known carriers in the art. Selection of suitable carriers depends upon the type of comestible being prepared.

For example, some embodiments are directed to a comestible in the form of a lozenge or candy, also commonly referred to as confectioneries. The carrier in confectionery compositions may include bulk sweeteners such as sugars and sugarless bulk sweeteners, or the like, or mixtures thereof. Bulk sweeteners generally are present in amounts of about 0.05% to about 99% by weight of the composition. Suitable sugar sweeteners and sugarless sweeteners are described in detail above in the discussion regarding sweetening compositions.

In some embodiments, high-intensity sweeteners also may be included in the confectionery compositions. Without being limited to particular sweeteners, representative categories and examples include:

(a) water-soluble sweetening agents such as dihydrochalcones, monellin, stevia, steviosides, rebaudioside A, glycyrrhizin, dihydroflavenol, and sugar alcohols such as sorbitol, mannitol, maltitol, xylitol, erythritol and L-aminodicarboxylic acid aminoalkenoic acid ester amides, such as those disclosed in U.S. Pat. No. 4,619,834, which disclosure is incorporated herein by reference, and mixtures thereof;

(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof;

(c) dipeptide based sweeteners, such as L-aspartic acid derived sweeteners, such as L-aspartyl-L-phenylalanine methyl ester (Aspartame) and materials described in U.S. Pat. No. 3,492,131, L-alphaaspartyl-N-(2,2,4,4-tetramethyl-3-thietanyl)-D-alaninamide hydrate (Alitame), N-[N-(3,3-dimethylbutyl)-L-aspartyl]-L-phenylalanine 1-methyl ester (Neotame), methyl esters of L-aspartyl-L-phenylglycerine and L-aspartyl-L-2,5-dihydrophenyl-glycine, L-aspartyl -2,5-dihydro-L-phenylalanine; L-aspartyl-L-(1-cyclohexen)-alanine, and mixtures thereof;

(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro4,6,1′,6′-tetradeoxygalacto-sucrose; and 4,6,1′,6′-tetradeoxy-sucrose, and mixtures thereof;

(e) protein based sweeteners such as thaumatococcus danielli (Thaumatin I and II) and talin;

(f) the sweetener monatin (2-hydroxy-2-(indol-3-ylmethyl)-4-aminoglutaric acid) and its derivatives; and

(g) the sweetener Lo han guo (sometimes also referred to as “Lo han kuo”).

The intense sweetening agents may be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and mixtures thereof.

In general, an effective amount of intense sweetener may be utilized to provide the level of sweetness desired, and this amount may vary with the sweetener selected. The intense sweetener may be present in amounts from about 0.001% to about 3%, by weight of the comestible, depending upon the sweetener or combination of sweeteners used. The exact range of amounts for each type of sweetener may be selected by those skilled in the art.

A variety of traditional ingredients also may be included in the confectioneries in effective amounts such as coloring agents, antioxidants, preservatives, and the like. Coloring agents may be used in amounts effective to produce the desired color. The coloring agents may include pigments which may be incorporated in amounts up to about 6%, by weight of the composition. For example, titanium dioxide may be incorporated in amounts up to about 2%, and preferably less than about 1%, by weight of the composition. The colorants may also include natural food colors and dyes suitable for food, drug and cosmetic applications. These colorants are known as F.D. & C. dyes and lakes. The materials acceptable for the foregoing uses are preferably water-soluble. Illustrative nonlimiting examples include the indigoid dye known as F.D. & C. Blue No. 2, which is the disodium salt of 5,5-indigotindisulfonic acid. Similarly, the dye known as F.D.& C. Green No. 1 comprises a triphenylmethane dye and is the monosodium salt of 4-[4-(N-ethyl-p-sulfoniumbenzylamino)diphenylmethylene]-[1-(N-ethyl-N-p-sulfoniumbenzyl)-delta -2,5-cyclohexadieneimine]. A full recitation of all F.D.& C. colorants and their corresponding chemical structures may be found in the Kirk-Othmer Encyclopedia of Chemical Technology, 3rd Edition, in volume 5 at pages 857-884, which text is incorporated herein by reference.

Lubricants also may be added in some embodiments to improve the smoothness of the comestible, such as, for example hard candy embodiments. Smoothness also is a characteristic that leads to an increased perception of mouth-moistening upon consumption. Suitable lubricants include, but are not limited to, fats, oils, aloe vera, pectin and combinations thereof.

Similarly, in some embodiments, the comestible may have smooth edges. In such embodiments, the comestible may have any shape, such as square, circular or diamond-shaped, however, the edges are rounded to provide a smooth comestible. Another manner of lending smoothness to the comestibles is to deposit the comestible composition into molds during the manufacturing process. Accordingly, in some embodiments, the comestible is deposited, as described in more detail below.

Other conventional additives known to one having ordinary skill in the art also may be used in the confectionery compositions.

The comestibles may provide a variety of interrelated benefits that lead to a feeling of salivation in the mouth of an individual. For instance, the comestibles may reduce and/or eliminate the sensation of dryness in the mouth, provide refreshment and/or a mouth-watering effect.

To determine the effectiveness of the comestibles at satisfying these attributes, trained taste panels may be employed. A number of different comestibles each containing different mouth-moistening compositions may be provided to a taste panel. Upon consumption of each comestible, the panel may rate a number of attributes based on predetermined scales, which are commonly accepted in the art.

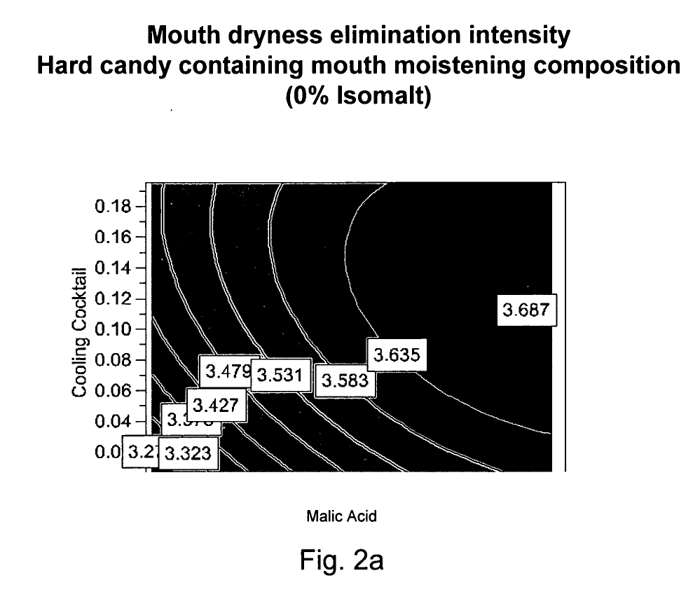

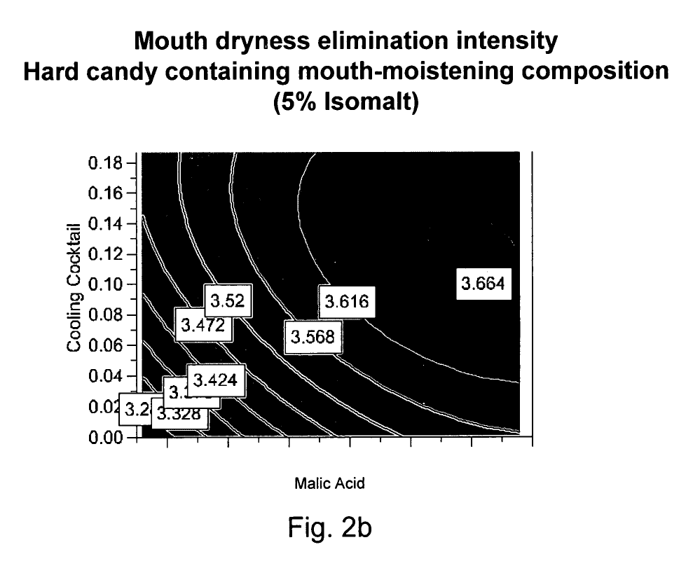

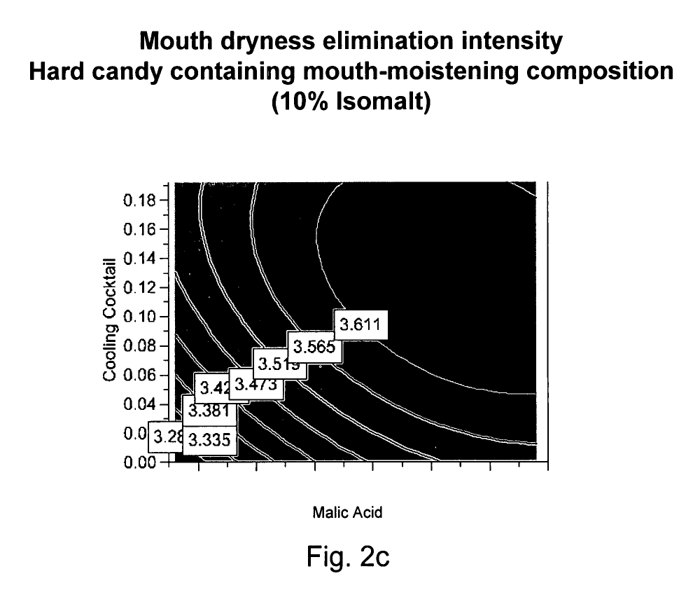

For instance, the ability of the comestible to reduce or eliminate mouth dryness may be rated on an intensity scale. Intensity scales commonly include a rating scale of 1-5, with 1 being not at all effective and 5 being extremely effective, as described in Morten Meilgaard et al., “Sensory Evaluation Techniques” 247 (3d ed. 1999). In some embodiments, the comestible may have a mouth dryness elimination intensity of at least about 3.6 on such a scale. FIGS. 2a-2c are graphical representations, i.e., contour plots, of the ratings of various comestibles for mouth dryness elimination intensity. As seen in FIGS. 2a-2c, ratings of about 3.6 or higher provide the greatest intensity of mouth dryness elimination as these are located in the highest region of the counter plots.

Also as seen in FIGS. 2a-2c, intensity ratings of about 3.6 or higher may be associated with certain levels of food-grade acid, cooling agent and sweetness reducing agent contained in the composition. More specifically, some embodiments, which produce a mouth dryness elimination intensity of at least 3.6, include a cooling agent in amounts of about 0.04% to about 0.2%, food-grade acid composition in amounts of about 2.5% to about 4.5% and sweetness reducing agent in amounts of about 0% to about 10% by weight of the comestible.

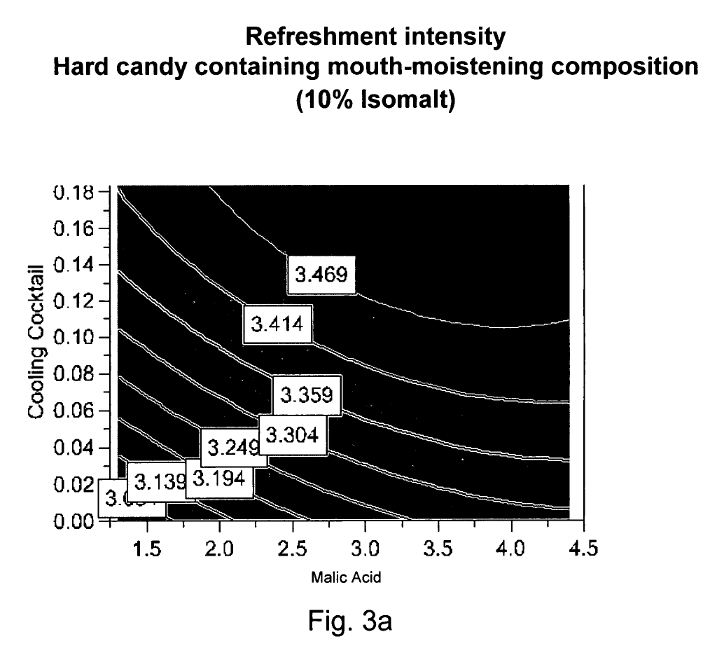

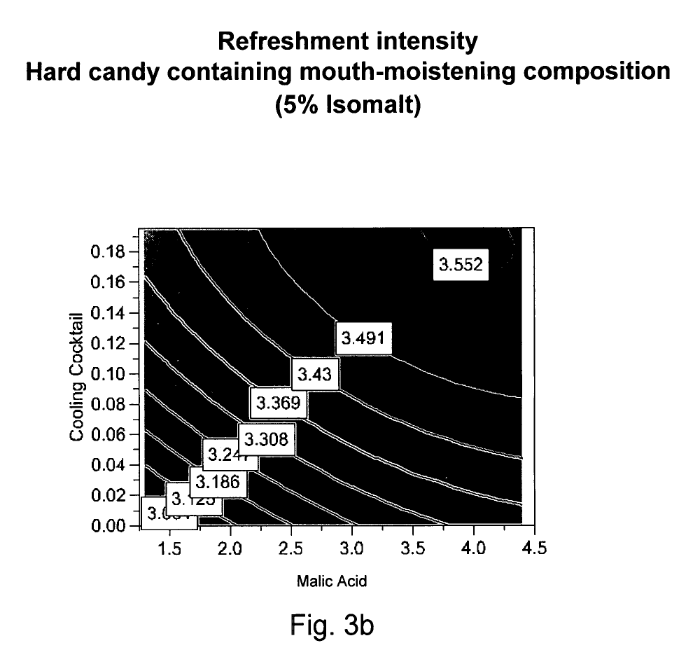

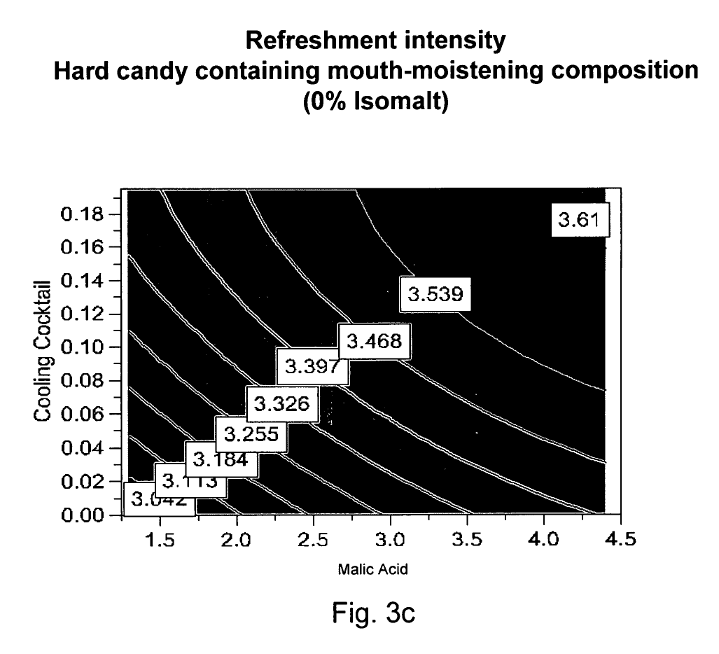

The ability of the comestibles to provide refreshment also may be measured by such an intensity scale. In accordance therewith, some embodiments may have a refreshment intensity of at least about 3.4 on such a scale of 1-5. FIGS. 3a-3c are graphical representations, i.e., contour plots, of the ratings of various comestibles for refreshment intensity. As seen in FIGS. 3a-3c, ratings of about 3.4 or higher, more desirably 3.5 or higher, provide the greatest intensity of refreshment as these are located in the highest regions of the contour plots.

Also seen in FIGS. 3a-3c, refreshment intensity ratings of about 3.4 or higher may be associated with certain levels of food-grade acid, cooling agent and sweetness reducing agent contained in the composition. More specifically, some embodiments, which produce a refreshment intensity of at least 3.4, include a cooling agent in amounts of about 0.08% to about 0.2%, food-grade acid composition in amounts of about 1.7% to about 4.5% and sweetness reducing agent in amounts of about 0% to about 10% by weight of the comestible.

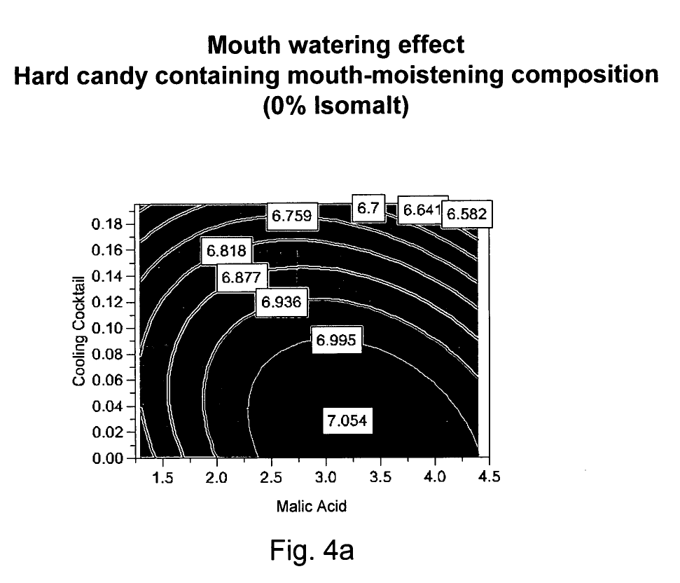

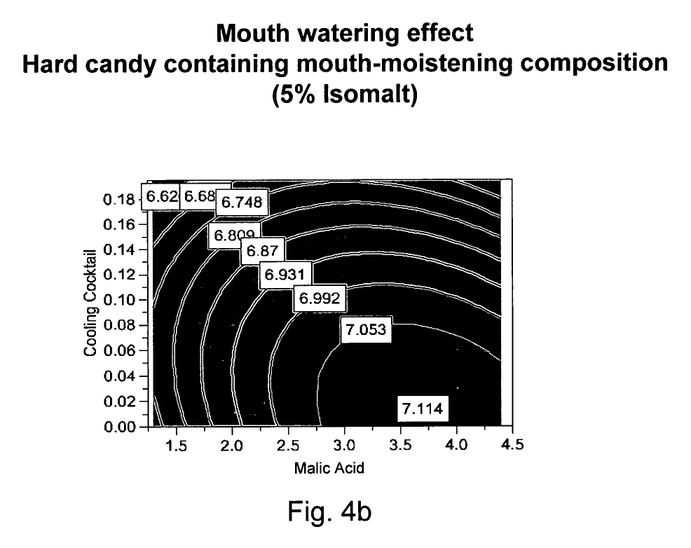

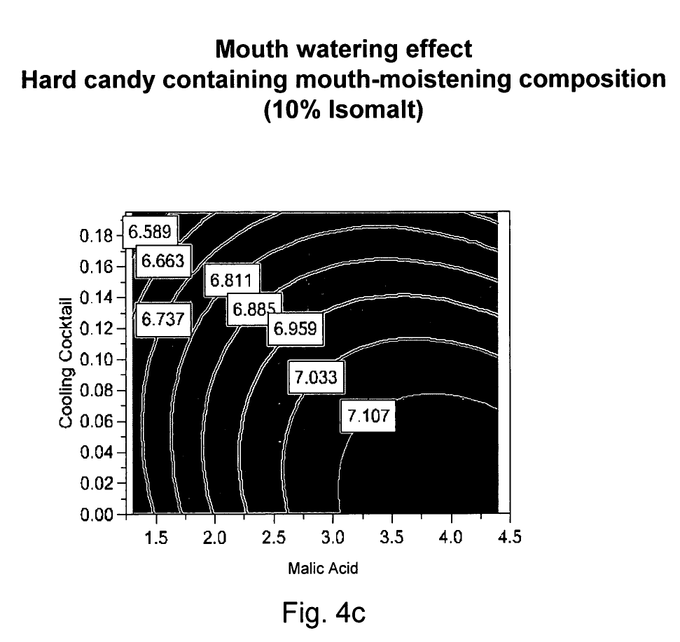

The ability of the comestibles to provide a mouth-watering effect may be measured on a different type of scale, i.e., a hedonic scale. Hedonic scales measure the level of liking for the specified attribute, as described in “Sensory Evaluation Techniques,” referred to above, at 242-43. For instance, how much the mouth-watering effect of a comestible is liked or disliked may be rated on a hedonic scale of 1-9, with 1 being disliked extremely and 9 being liked extremely. In some embodiments, the comestible may have a mouth-watering effect of at least about 7 on such a scale. FIGS. 4a-4c are graphical representations, i.e., contour plots, of the ratings of various comestibles for mouth-watering effect. As seen in FIGS. 4a-4c, ratings of about 7 or higher provide the greatest liking of mouth-watering effect as these are located in the highest regions of the contour plots.

Also seen in FIGS. 4a-4c, mouth-watering ratings of about 7 or higher may be associated with certain levels of food-grade acid, cooling agent and sweetness reducing agent contained in the composition. More specifically, some embodiments, which produce a mouth-watering effect of at least 7, include a cooling agent in amounts of about 0% to about 0.09%, food-grade acid composition in amounts of about 2.3% to about 4.5% and sweetness reducing agent in amounts of about 0% to about 10% by weight of the comestible.

Some embodiments are directed to methods of preparing confectionery compositions. Such confections may be prepared using conventional apparatus such as fire cookers, cooking extruders, and/or vacuum cookers.

In accordance with some embodiments, the sweetening composition, e.g., sugar sweetener and sweetness reducing agent, and any additional carrier (e.g., bulk sweetener) as well as a solvent (e.g., water), are combined in a mixing vessel to form a slurry. The slurry is heated to about 70° C. to 120° C. to dissolve any sweetener crystals or particles and form an aqueous solution. Once dissolved, heat at temperatures of about 135° C. to 160° C. and vacuum are applied to cook the batch and boil off water until a residual moisture of less than about 4% is achieved. The batch changes from a crystalline to an amorphous phase. The flavor agent, food-grade acid composition and optionally cooling agent(s) are then admixed in the batch by mechanical mixing operations, along with any other optional additives, such as coloring agents.

The optimum mixing required to uniformly mix the sweetening compositions, flavors, food-grade acid compositions, cooling agents, colorants and other additives during manufacturing of a confectionery is determined by the time needed to obtain a uniform distribution of the materials. Normally, mixing times of from four to ten minutes have been found to be acceptable.

In some embodiments, the batch is then cooled to about 100° C. to 20° C. to attain a semi-solid or plastic-like consistency. Once the candy mass has been properly tempered, it may be cut into workable portions or formed into desired shapes having the correct weight and dimensions. A variety of forming techniques may be utilized depending upon the shape and size of the final product desired. Once the desired shapes are formed, cool air is applied to allow the comestibles to set uniformly, after which they are wrapped and packaged.

In other embodiments, the mixed batch is deposited into molds of any desired shape and size. Cool air then may be applied to allow the molded comestibles to set uniformly, after which the comestibles may be removed, wrapped and packaged.

The apparatus useful in accordance with some embodiments comprises cooking and mixing apparatus well known in the confectionery manufacturing arts, and selection of the specific apparatus will be apparent to one skilled in the art.

In accordance with the preparation methods described above, some confectionery embodiments are directed to a pre-mix, which includes a homogenous dry blend of sugar and a sweetness reducing agent. The pre-mix also may include a food-grade acid composition and a cooling agent, as described above. Other embodiments are directed to compositions which include a cooked amorphous matrix including sugar and a sweetness reducing agent, a food-grade acid composition and a cooling agent.

Still other confectionery embodiments relate to dividable or, alternatively, molded candy masses. The dividable candy mass may include a mouth-moistening composition, a flavor agent and optionally a carrier, as described above. The moldable candy mass may include a mouth-moistening composition which is a molded blend of a sweetening composition, food-grade acid composition and cooling agent. The molded candy mass also may include a flavor agent and optionally a carrier.

Some embodiments are directed to center-filled products, such as center-filled candy or center-filled chewing gum. Such products generally include a center-fill region and a region that at least partially surrounds the center-fill region. The region that at least partially surrounds the center-fill region may be a candy composition, in center-fill candy embodiments, or a gum composition, in center-fill chewing gum embodiments. Suitable candy, or confectionery, compositions are described above. Chewing gum compositions are described in more detail below.

The center-fill region in some embodiments may be a liquid, solid or semi-solid, gas, or the like. For example, in some embodiments, the center-fill region may be a powdered confectionery composition. Center-fill compositions may include any of the sweeteners, flavors, cooling agents, coloring agents and the like described above.

In some embodiments, the center-fill region may be substantially or completely filled with the liquid, solid, semi-solid or gaseous center-fill composition. In some other embodiments, the center-fill region may be only partially filled with the liquid, solid, semi-solid or gaseous center-fill composition.

In some embodiments, the center-fill region may include two or more center-fill compositions. The two or more center-fill compositions may be the same or different forms. For example, some embodiments may contain a mixture of two or more distinct liquids, which may or may not be miscible. Similarly, some embodiments may contain two or more distinct solids, semi-solids or gasses in the center-fill region. Mixtures of different center-fill forms also may be included in some embodiments. For example, a liquid and a solid may be included in the center-fill region. The two or more liquids, solids, semi-solids and/or gasses employed in the center-fill region may be included in the same or different amounts and may have similar or distinct characteristics. More specifically, in some embodiments, the two or more center-fill compositions may differ in a variety of characteristics, such as, viscosity, color, flavor, taste, texture, sensation, ingredient components, functional components, sweeteners, or the like.

In some embodiments, the center-fill composition also may include non-liquid components, such as, for example, flavor beads, fruit particles, nut particles, flavor particles, gelatin beads or portions, and the like.

In some embodiments, the mouth-moistening composition may be present in the center-fill region, the candy or gum region, which at least partially surrounds the center-fill region, or both regions. Some embodiments may include a first mouth-moistening composition in the center-fill region and a second mouth-moistening composition in the candy or gum region. The second mouth-moistening composition may be the same as or different from the first.

Some center-fill embodiments optionally may include a third, or coating, region. In some embodiments, the coating also may be referred to as the “outermost region” of the product. The coating may at least partially surround the candy or gum region. The coating may be any conventional sugar or sugarless coating, which forms an exterior surface on the center-filled product.

A variety of coating processes or mechanisms are known. In some embodiments, the coating is applied in numerous thin layers of material in order to form an appropriate uniform coated and finished quality surface on the products. The hard coating material, which may include sugar, maltitol, sorbitol or any other polyol, including those described herein, and optionally flavoring, is sprayed onto the pellets of material as they pass through a coating mechanism or a coating tunnel and are tumbled and rotated therein. In addition, conditioned air is circulated or forced into the coating tunnel or mechanism in order to dry each of the successive coating layers on the formed products. In some embodiments, the coating, or outermost region, can be formed by lamination, dual or multiple extrusion, or any other process that creates an outermost region.

In addition to hard coatings, other types of coatings can include gumming or glazing, soft coating, smoothing, frosting, sanding, and wet crystallization. These coating processes are described in more detail in U.S. Pat. No. 5,527,542 which is incorporated by reference herein in its entirety. Further, the exterior or outermost region can be a lipid material such as an oil. This lipid material can be applied to the product by any suitable means.

For additional disclosure of various center-fill products and methods of making center-fill products, particularly, center-fill chewing gum, see the following co-pending commonly owned patent applications, the contents of which are incorporated herein by reference in their entirety: U.S. Application No. 60/776,748, filed on Feb. 24, 2006, entitled “Liquid-Filled Chewing Gum Composition”; U.S. Application No. 60/776,642, filed on Feb. 24, 2006, entitled “Liquid-Filled Chewing Gum Composition”; U.S. application Ser. No. 11/408,761, filed on Apr. 21, 2006, entitled “Liquid-Filled Chewing Gum Composition”; U.S. application Ser. No. 11/411,543, filed on Apr. 26, 2006, entitled “Center-Filled Chewing Gum with Barrier Layer”; U.S. application Ser. No. 11/414,919, filed on May 1, 2006, entitled “Center-Filled Chewing Gum Composition”; U.S. application Ser. No. 11/410,962, filed on Apr. 25, 2006, entitled “Center-Filled Chewing Gum Composition”; U.S. application Ser. No. 11/415,043, filed on May 1, 2006, entitled “Multi-Modality Flavored Chewing Gum Compositions”; U.S. application Ser. No. 11/415,044, filed on May 1, 2006, entitled “Multi-Modality Sensations in Chewing Gum Compositions”; U.S. application Ser. No. 11/415,006, filed on May 1, 2006, entitled “Multi-Modality Tastes in Chewing Gum Compositions”; and U.S. application Ser. No. 11/415,012, filed on May 1, 2006, entitled “Multi-Modality Functional Ingredients in Chewing Gum Compositions.”

Some embodiments are directed to chewing gum compositions. The carrier in chewing gum compositions may include a chewable carrier, such as a chewing gum base and other optional components. The chewing gum base may be a water-soluble chewing gum base and/or a water-insoluble chewing gum base. The gum base may include any component known in the chewing gum art. For example, the gum base may include elastomers, bulking agents, waxes, elastomer solvents, emulsifiers, plasticizers, fillers and mixtures thereof.

The elastomers (rubbers) employed in the gum base will vary greatly depending upon various factors such as the type of gum base desired, the consistency of gum composition desired and the other components used in the composition to make the final chewing gum product. The elastomer may be any water-insoluble polymer known in the art, and includes those gum polymers utilized for chewing gums and bubble gums. Illustrative examples of suitable polymers in gum bases include both natural and synthetic elastomers. For example, those polymers which are suitable in gum base compositions include, without limitation, natural substances (of vegetable origin) such as chicle, natural rubber, crown gum, nispero, rosidinha, jelutong, perillo, niger gutta, tunu, balata, guttapercha, lechi capsi, sorva, gutta kay, and the like, and mixtures thereof. Examples of synthetic elastomers include, without limitation, styrene-butadiene copolymers (SBR), polyisobutylene, isobutylene-isoprene copolymers, polyethylene, polyvinyl acetate and the like, and mixtures thereof.

The amount of elastomer employed in the gum base may vary depending upon various factors such as the type of gum base used, the consistency of the gum composition desired and the other components used in the composition to make the final chewing gum product. In general, the elastomer will be present in the gum base in an amount from about 10% to about 60% by weight, desirably from about 35% to about 40% by weight.

In some embodiments, the gum base may include wax. It softens the polymeric elastomer mixture and improves the elasticity of the gum base. When present, the waxes employed will have a melting point below about 60° C., and preferably between about 45° C. and about 55° C. The low melting wax may be a paraffin wax. The wax may be present in the gum base in an amount from about 6% to about 10%, and preferably from about 7% to about 9.5%, by weight of the gum base.

In addition to the low melting point waxes, waxes having a higher melting point may be used in the gum base in amounts up to about 5%, by weight of the gum base. Such high melting waxes include beeswax, vegetable wax, candelilla wax, carnuba wax, most petroleum waxes, and the like, and mixtures thereof.

In addition to the components set out above, the gum base may include a variety of other ingredients, such as components selected from elastomer solvents, emulsifiers, plasticizers, fillers, and mixtures thereof.

The gum base may contain elastomer solvents to aid in softening the elastomer component. Such elastomer solvents may include those elastomer solvents known in the art, for example, terpinene resins such as polymers of alpha-pinene or beta-pinene, methyl, glycerol and pentaerythritol esters of rosins and modified rosins and gums such as hydrogenated, dimerized and polymerized rosins, and mixtures thereof. Examples of elastomer solvents suitable for use herein may include the pentaerythritol ester of partially hydrogenated wood and gum rosin, the pentaerythritol ester of wood and gum rosin, the glycerol ester of wood rosin, the glycerol ester of partially dimerized wood and gum rosin, the glycerol ester of polymerized wood and gum rosin, the glycerol ester of tall oil rosin, the glycerol ester of wood and gum rosin and the partially hydrogenated wood and gum rosin and the partially hydrogenated methyl ester of wood and rosin, and the like, and mixtures thereof. The elastomer solvent may be employed in the gum base in amounts from about 2% to about 15%, and preferably from about 7% to about 11%, by weight of the gum base.

The gum base may also include emulsifiers which aid in dispersing the immiscible components into a single stable system. The emulsifiers useful in some embodiments include glyceryl monostearate, lecithin, fatty acid monoglycerides, diglycerides, propylene glycol monostearate, and the like, and mixtures thereof. The emulsifier may be employed in amounts from about 2% to about 15%, and more specifically, from about 7% to about 11%, by weight of the gum base.

The gum base may also include plasticizers or softeners to provide a variety of desirable textures and consistency properties. Because of the low molecular weight of these ingredients, the plasticizers and softeners are able to penetrate the fundamental structure of the gum base making it plastic and less viscous. Useful plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerine, and the like, and mixtures thereof. Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, mixtures thereof, and the like, may also be incorporated into the gum base. The plasticizers and softeners are generally employed in the gum base in amounts up to about 20% by weight of the gum base, and more specifically in amounts from about 9% to about 17%, by weight of the gum base.

Plasticizers also include hydrogenated vegetable oils, such as soybean oil and cottonseed oils, which may be employed alone or in combination. These plasticizers provide the gum base with good texture and soft chew characteristics. These plasticizers and softeners are generally employed in amounts from about 5% to about 14%, and more specifically in amounts from about 5% to about 13.5%, by weight of the gum base.

Anhydrous glycerin may also be employed as a softening agent, such as the commercially available United States Pharmacopeia (USP) grade. Glycerin is a syrupy liquid with a sweet warm taste and has a sweetness of about 60% of that of cane sugar. Because glycerin is hygroscopic, the anhydrous glycerin may be maintained under anhydrous conditions throughout the preparation of the chewing gum composition.

In some embodiments, the gum base also may include effective amounts of bulking agents such as mineral adjuvants which may serve as fillers and textural agents. Useful mineral adjuvants include calcium carbonate, magnesium carbonate, alumina, aluminum hydroxide, aluminum silicate, talc, tricalcium phosphate, dicalcium phosphate, calcium sulfate and the like, and mixtures thereof. These fillers or adjuvants may be used in the gum base compositions in various amounts. Preferably the amount of filler, when used, will be present in an amount from about 15% to about 40%, and desirably from about 20% to about 30%, by weight of the gum base.

A variety of traditional ingredients may be optionally included in the gum base in effective amounts such as flavor agents and coloring agents described above, antioxidants, preservatives, and the like. For example, titanium dioxide and other dyes suitable for food, drug and cosmetic applications, known as F. D. & C. dyes, may be utilized. An anti-oxidant such as butylated hydroxytoluene (BHT), butylated hydroxyanisole (BHA), propyl gallate, vitamin E and mixtures thereof, may also be included. Other conventional chewing gum additives known to one having ordinary skill in the chewing gum art may also be used in the gum base.

The chewing gum compositions may include amounts of conventional additives selected from the group consisting of sweetening agents, plasticizers, softeners, emulsifiers, waxes, fillers, bulking agents (carriers, extenders, bulk sweeteners), mineral adjuvants, flavor agents and coloring agents discussed above, antioxidants, acidulants, thickeners, medicaments, and the like, and mixtures thereof. Some of these additives may serve more than one purpose. For example, in sugarless gum compositions, a sweetener, such as maltitol or other sugar alcohol, may also function as a bulking agent.

Bulk sweeteners, as described above, generally are present in amounts of about 5% to about 95% by weight of the chewing gum composition.

The plasticizers, softening agents, mineral adjuvants, waxes and antioxidants discussed above, as being suitable for use in the gum base, may also be used in the chewing gum composition. Examples of other conventional additives which may be used include emulsifiers, such as lecithin and glyceryl monostearate, thickeners, used alone or in combination with other softeners, such as methyl cellulose, alginates, carrageenan, xanthan gum, gelatin, carob, tragacanth, locust bean, and carboxy methyl cellulose, acidulants such as malic acid, adipic acid, citric acid, tartaric acid, fumaric acid, and mixtures thereof, and fillers, such as those discussed above under the category of mineral adjuvants.

Other conventional gum additives known to one having ordinary skill in the chewing gum art also may be used in the chewing gum compositions.

Methods of making chewing gum are not discussed in detail herein as they are well known to one having ordinary skill in the chewing gum art. For general chewing gum preparation processes see U.S. Pat. No. 4,271,197 to Hopkins et al, U.S. Pat. No. 4,352,822 to Cherukuri et al and U.S. Pat. No. 4,497,832 to Cherukuri et al, each of which is incorporated herein by reference in its entirety.

Methods of preparing other comestible products, including soft candy, cotton candy, pressed tablets, film, liquid and powdered beverages, and the like also are well known to those having ordinary skill in the art and need not be discussed in detail herein.

Some embodiments provide methods of improving the mouth-watering effect of a comestible. In accordance therewith, a composition including a blend of components is provided. The components may include a food-grade acid composition, as described above, and a sweetening composition. The sweetening composition may be a sugar sweetener. The sweetness of the composition may be reduced by adding a sweetness reducing agent, as described above, to the composition prior to forming the comestible. The sweetness reducing agent may be blended in with the sugar sweetener and food-grade acid composition. Other components, such as cooling agents and flavor agents, also may be included.

Some embodiments are directed to methods of treating xerostomia, or other dry mouth conditions. In accordance with such methods, a comestible containing a mouth-moistening composition, as described above, a flavor agent and optionally a carrier is provided. The comestible is applied to the oral cavity of an individual experiencing mouth dryness. Upon contact with saliva, the comestible dissolves and releases the mouth-moistening composition, thereby reducing the feeling of mouth dryness of the individual.

The features and advantages of the present invention are more fully shown by the following examples which are provided for purposes of illustration, and are not to be construed as limiting the invention in any way.

### EXAMPLES

### Example 1

TABLE 1
Mouth-moistening composition

| Component | % by Weight |
|---|---|
| Isomalt | 62.91 |
| Malic Acid | 35.86 |
| Cooling agents¹ | 1.23 |

¹WS-23 and other proprietary cooling agents available from International Flavors & Fragrances, Inc. (IFF)

The components listed in Table 1 above were combined to form a mouth-moistening composition. The mouth-moistening composition was incorporated into a variety of different sugar-based comestibles.

### Example 2

TABLE 2
Mouth-moistening composition in hard boiled candy

| Component | % by weight |
|---|---|
| Candy Base (sugar, glucose syrup 42DE and water) | 86.48 |
| Isomalt (50% in water) | 10.00 |
| Malic acid | 2.85 |
| Cooling agents¹ | 0.0975 |
| Orange flavor | 0.17 |
| Color solution | 0.40 |

¹WS-23 and other proprietary cooling agents available from IFF

A hard boiled candy was prepared according to the formulation in Table 2 above.

A 50% aqueous preparation of isomalt was mixed thoroughly and heated to 90° C. The homogeneous solution was added to the sugar/glucose mixture and the entire batch was heated to 146° C. The batch was placed on a cooling table where color, malic acid, cooling agents and flavor were added. The batch was kneaded and the roll candies were dropped into the desired weight and size pieces.

### Example 3

TABLE 3
Mouth-moistening composition in soft/chewy candy

| Component | % by weight |
|---|---|
| Sugar, corn syrup and water | 73.46 |
| Isomalt (50% solution in water) | 10.00 |
| Fat | 8.25 |
| Gel base (gelatin +/− pectin) and water | 5.00 |
| Malic acid | 2.85 |
| Cooling agents¹ | 0.0975 |
| Color solution | 0.10 |
| Strawberry flavor | 0.25 |

¹WS-23 and other proprietary cooling agents available from IFF

A soft, chewy candy was prepared according to the formulation in Table 3 above.

The candy composition was prepared by first forming the gel base by adding gelatin, with or without pectin, to warm water and then mixing. The gel base was then combined with malic acid and color solution and mixed in a Hobart mixer.

The base candy mixture (isomalt solution/sugar/corn syrup) was heated to about 135° C. and added to the gel base and other components in the Hobart mixer. The combination was mixed at speed number three for thirty seconds and then mixed at speed number two for five minutes.

The fat was heated until it melted and then combined with the flavor and cooling agents to form a premix. The Hobart mixer speed then was reduced to number one and the melted fat was added thereto.

The mixer speed was changed to number three for thirty seconds, then down to speed number two for three minutes, and then down to speed number one at which point the pulverized sugar was added. The batch was again mixed for two minutes and then poured onto a cooling table. The batch was folded until cool, sampled and hand-pulled for one and a half minutes. The batch was poured into molds and subsequently grained and cut into the desired piece weight and size.

### Example 4

Tables 4 and 5: Mouth-Moistening Composition in Center-Filled Hard-Boiled Candy

TABLE 4
Hard candy shell composition (80%)

| Component | % by weight |
|---|---|
| Candy Base (sugar, glucose syrup 42DE and water) | 88.23 |
| Isomalt (50% in water) | 10.00 |
| Citric acid | 1.20 |
| Orange Flavor | 0.17 |
| Color solution | 0.40 |

TABLE 5
Liquid/gel center composition (20%)

| Component | % by weight |
|---|---|
| High fructose corn syrup | 34.69 |
| Isomalt (50% in water) | 50.00 |
| Malic acid | 14.25 |
| Cooling agents¹ | 0.4875 |
| Raspberry flavor | 0.17 |
| Color solution | 0.40 |

¹WS-23 and other proprietary cooling agents available from IFF

A liquid-centered hard boiled candy was prepared according to the formulation in Tables 4 and 5 above.

Liquid-centered hard-boiled candies consisting of a hard-candy shell and a liquid/gel-like center were prepared using separate batch processes.

The shell material was prepared as described in Example 2 above. Briefly, the hot isomalt solution was added to the sugar/glucose syrup that has been pre-dissolved in water and cooked to 146° C. Citric acid, color and flavor were added to the cooked sugar mass. The batch was kneaded to a homogenous amorphous mass ready for forming.

For the liquid center, high fructose corn syrup, isomalt solution and liquid sugar were mixed, cooked to 120° C. and cooled immediately. Glycerin, color, flavor and cooling agents were mixed into the high fructose/sugar mass.

The amorphous cooked shell material was punched first, using a confections mold, to form the lower shell of the lozenge. A pre-determined weight of liquid center material was introduced via a syringe and placed in the bottom shell. The top half-shell was formed by punching another layer of amorphous candy mass to form a tight seal around the perimeters of the lozenge.

### Example 5

TABLE 6
Mouth-moistening composition in chewing gum slab

| Component | % by weight |
|---|---|
| Gum base | 30.00-53.00 |
| Isomalt (50% solution in water) | 5.00-10.00 |
| Lecithin (solid) | 0.40-0.70 |
| Acetylated monoglycerides (distilled) | 0.40-0.70 |
| Sorbitol (crystalline) | 33.59-43.59 |
| Mannitol | 12.50-22.50 |
| Malic acid | 2.00-3.25 |
| Xylitol | 9.59-14.59 |
| Glycerin | 5.50-10.50 |
| Cooling agents¹ | 0.0975 |
| Sweetening agents (both encapsulated and non- | 4.13-8.34 |
| encapsulated) | |
| Raspberry flavor | 3.75-11.75 |
| Color solution | 0.40-0.70 |

¹WS-23 and other proprietary cooling agents available from IFF

A chewing gum composition is prepared according to the composition in Table 6 above.

The chewing gum composition is prepared by first melting the gum base at a temperature of about 150-175° F. Once melted and placed in a standard mixer, the remaining ingredients are added and thoroughly mixed for about 1 to about 20 minutes. The resulting mix is formed into the desired final shape using a laboratory-size extruder, rolled and cut into slabs, and then optionally coated.

### Example 6

Tables 7 and 8: Mouth-Moistening Composition in Center-Filled Chewing Gum

TABLE 7
Gum/Shell composition (80)

| Component | % by weight |
|---|---|
| Gum base | 30.00-53.00 |
| Lecithin (solid) | 0.40-0.70 |
| Acetylated monoglycerides (distilled) | 0.40-0.70 |
| Sorbitol (crystalline) | 33.59-43.59 |
| Mannitol | 12.50-22.50 |
| Xylitol | 9.59-14.59 |
| Glycerin | 5.50-10.50 |
| Sweetening agents (both encapsulated and non- | 4.13-8.34 |
| encapsulated) | |
| Raspberry flavor | 3.75-11.75 |
| Color solution | 0.40-0.70 |

TABLE 8
Liquid/gel center composition (20%)

| Component | % by weight |
|---|---|
| High fructose corn syrup | 34.69 |
| Isomalt (50% in water) | 50.00 |
| Malic acid | 14.25 |
| Cooling agents¹ | 0.4875 |
| Lemon flavor | 0.17 |
| Color solution | 0.40 |

¹WS-23 and other proprietary cooling agents available from IFF

A liquid-centered chewing gum was prepared according to the formulation in Tables 7 and 8 above.

Liquid-centered chewing gum consisting of a gum shell and a liquid/gel-like center were prepared using separate batch processes.

The shell gum composition was prepared by first melting the gum base at a temperature of about 150-175° F. Once melted and placed in a standard mixer, the remaining ingredients were added and thoroughly mixed for about 1 to about 20 minutes. The resulting mix then was formed into the desired final shape using a laboratory-size extruder, rolled and cast into molds to form bottom and top shells.

For the liquid center, high fructose corn syrup, isomalt solution and liquid sugar were mixed, cooked to 120° C. and cooled immediately. Glycerin, color, flavor and cooling agents were mixed into the high fructose/sugar mass.

The bottom shell was placed in a holder where a pre-determined weight of liquid center material was introduced via a syringe. The top shell was placed immediately onto the bottom shell and crimped firmly to form a tight seal around the perimeters of the gum piece.

### Example 7

TABLE 9
Sugar-free pressed mints

| Component | % by weight |
|---|---|
| Sorbitol P60W | 19.15 |
| Sorbitol 20/60 | 7.45 |
| Xylitol Milled | 25.00 |
| Sorbitol P60W | 44.64 |
| Malic acid | 2.85 |
| Aspartame | 0.29 |
| Ace-K | 0.05 |
| Flavor | 0.27 |
| Cooling agents¹ | 0.0975 |
| Magnesium stearate | 0.20 |

¹WS-23 and other proprietary cooling agents available from IFF

A sugar-free pressed mint is prepared according to the formulation in Table 9 above.

Sugar-free pressed mints are prepared using wet granulation of the sorbitols and xylitol mixture followed by drying and milling. Magnesium stearate, aspartame, Ace-K, cooling agents and flavors are added to the sorbitol/xylitol dried blend and mixed thoroughly followed by a secondary granulation process. The mixture is compressed into tablets of pre-determined weight and dimensions.

### Example 8

TABLE 10
Sugared pressed mints

| Component | % by weight |
|---|---|
| Pressed mint pre-mix (sugared) | 94.90 |
| Malic acid | 2.85 |
| Copper gluconate/magnesium stearate sugar premix | 0.75 |
| Flavor (liquid/dry/speckles) | 1.20 |
| Cooling agents¹ | 0.0975 |
| Magnesium stearate | 0.20 |

¹WS-23 and other proprietary cooling agents available from IFF

A sugared pressed mint is prepared according to the formulation in Table 10 above.

Sugared pressed mints are prepared using wet granulation of the sugar premix followed by drying and milling. Magnesium stearate, copper gluconate sugar mix, flavors and cooling agents are added and mixed thoroughly followed by a secondary granulation process. The mixture is compressed into tablets of pre-determined weight and dimensions.

### Example 9

Tables 11, 12, 13 and 14: Mouth-Moistening Composition in Center-Filled Hard-Boiled Candy

TABLE 11
Hard candy shell composition (93.5%)

| Component | % by weight |
|---|---|
| Candy Base (sugar, glucose syrup 42DE and water) | 88.23 |
| Isomalt (50% in water) | 10.00 |
| Citric acid | 1.20 |
| Orange Flavor | 0.17 |
| Color solution | 0.40 |

TABLE 12
Powdered center composition (6.5%)

| Component | % by weight |
|---|---|
| Erythritol | 100 |

TABLE 13
Powdered center composition (6.5%)

| Component | % by weight |
|---|---|
| Erythritol | 95.5-100.0 |
| Cooling compounds (powder/encapsulated) | 0.0-2.0 |
| Flavor | 0.0-2.5 |

TABLE 14
Powdered center composition (6.5%)

| Component | % by weight |
|---|---|
| Erythritol | 50.0-100.0 |
| Xylitol (or other polyols and/or sugar) | 50.0-100.0 |
| Cooling compounds (powder/encapsulated) | 0.0-2.0 |
| Flavor | 0.0-2.5 |

Powder-centered hard boiled candies are prepared according to the formulations in Tables 11-14 above. Three different powder-centered hard boiled candies are prepared, each including the hard shell candy composition provided in Table 11 above and one of the powdered center-fill compositions from Tables 12-14 above.

The shell material is prepared as described in Example 2 above. Briefly, the hot isomalt solution is added to the sugar/glucose syrup that is pre-dissolved in water and cooked to 146° C. Citric acid, color and flavor are added to the cooked sugar mass. The batch is kneaded to a homogenous amorphous mass ready for forming.

For the powder center, erythritol or other powdered polyol and/or their combinations with sugars (sucrose, galactose, lactose, and the like) are placed on a hot table for various periods of time to ensure their free-flow behavior.

The amorphous cooked shell material is punched first, using a confections mold, to form the lower shell of the lozenge, or candy. A pre-determined weight of powder center material is introduced via a small spatula and placed in the bottom shell. The top half-shell is formed by punching another layer of amorphous candy mass to form a tight seal around the perimeters of the lozenge.

1. A comestible comprising:
(a) a composition comprising a blend of:
(i) a sweetening composition comprising sugar and a sweetness reducing agent;
(ii) a food-grade acid composition; and
(iii) optionally a cooling agent;
(b) a flavor agent; and
(c) optionally a carrier.

2. The comestible of claim 1, wherein said blend is homogenous.

3. The comestible of claim 1, wherein said sweetening composition is present in amounts of about 0.05% to about 99.5% by weight of said comestible.

4. The comestible of claim 1, wherein said food-grade acid composition is present in amounts of about 0.01% to about 20% by weight of said comestible.

5. The comestible of claim 1, wherein said cooling agent is present in amounts of about 0.001% to about 1.5% by weight of said comestible.

6. The comestible of claim 1, wherein said food-grade acid composition comprises malic acid.

7. The comestible of claim 6, wherein said food-grade acid composition further comprises an acid selected from the group consisting of: acetic acid; adipic acid; ascorbic acid; butyric acid; citric acid; formic acid; fumaric acid; glyconic acid; lactic acid; phosphoric acid; oxalic acid; succinic acid; tartaric acid; and combinations thereof.

8. The comestible of claim 6, wherein said food-grade acid composition further comprises one or more acids having a pKa of about 1 to about 5.

9. The comestible of claim 6, wherein said malic acid is present in an amount sufficient to produce a mouth-moistening perception from less than about 1 minute to about 3 minutes after the comestible is substantially consumed.

10. The comestible of claim 1, further comprising a lubricant selected from the group consisting of fats, oils, aloe vera, pectin and combinations thereof.

11. The comestible of claim 1, wherein said comestible has smooth edges.

12. The comestible of claim 1, wherein said comestible is deposited.

13. The comestible of claim 1, wherein said cooling agent is selected from the group consisting of menthol, xylitol, erythritol, menthane, menthone, menthyl acetate, menthyl salicylate, N,2,3-trimethyl-2-isopropyl butanamide, N-ethyl-p-menthane-3-carboxamide, menthyl succinate, 3,1-menthoxypropane 1,2-diol; glutarate esters; and combinations thereof.

14. The comestible of claim 1, wherein said cooling agent comprises a glutarate ester and N,2,3-trimethyl-2-isopropyl butanamide.

15. The comestible of claim 1, wherein said comestible is substantially free of menthol.

16. The comestible of claim 1, wherein said sweetness reducing agent is selected from the group consisting of sweetness receptor blockers, sugarless sweetening agents, non-sucrose saccharides, proteins, glycoproteins, oligoproteins, polyols, glycerol, fats, waxes and combinations thereof.

17. The comestible of claim 16, wherein said sweetness receptor blockers are selected from the group consisting of: ethers or thioethers of acetic acid derivatives; salts of substituted benzoylalkyl carboxylic acids; 3-aminobenzenesulfonic acid; derivatives of 3-aminobenzenesulfonic acid; substituted phenylalkyl carboxylic acid salts; substituted phenyl ketoalkyl carboxylic acid salts; substituted benzoyloxy acetic acid salt derivatives; 2-propionic acid salt derivatives; 2-p-methoxyphenoxypropionic acid; p-methoxybenzylacetic acid; and mixtures thereof.

18. The comestible of claim 16, wherein said sugarless sweetening agents are selected from the group consisting of sorbitol, xylitol, mannitol, galactitol, maltitol, hydrogenated isomaltulose (isomalt), lactitol, erythritol, hydrogenated starch hydrolysate, stevia and mixtures thereof.

19. The comestible of claim 1, wherein said sweetness reducing agent comprises isomalt alone or in combination with maltitol.

20. The comestible of claim 1, wherein said flavor agent comprises a citrus flavor.

21. A comestible comprising:
(a) a composition comprising a blend of:
(i) a sweetening composition comprising sugar and a sweetness reducing agent;
(ii) a food-grade acid composition; and
(iii) optionally a cooling agent;
(b) a flavor agent; and
(c) optionally a carrier,
wherein said comestible has a mouth dryness elimination intensity of at least about 3.6 on a scale of 1-5.

22. The comestible of claim 21, wherein said sweetening composition is present in amounts of about 1% to about 99.5% by weight of said comestible.

23. The comestible of claim 21, wherein said food-grade acid composition is present in amounts of about 0.01% to about 20% by weight of said comestible.

24. The comestible of claim 21, wherein said cooling agent is present in amounts of about 0.001% to about 1.5% by weight of said comestible.

25. A comestible comprising:
(a) a composition comprising a homogenous blend of:
(i) a sweetening composition comprising sugar and isomalt alone or in combination with maltitol;
(ii) a food-grade acid composition comprising malic acid present in amounts of about 2.5% to about 5% by weight of said comestible; and
(iii) a cooling agent present in amounts of about 0.03% to about 0.2% by weight of said comestible;
(b) a flavor agent; and
(c) optionally a carrier.

26. A comestible comprising:
(a) a composition comprising a blend of:
(i) a sweetening composition comprising sugar and a sweetness reducing agent;
(ii) a food-grade acid composition; and
(iii) optionally a cooling agent;
(b) a flavor agent; and
(c) optionally a carrier,
wherein said comestible has a refreshment intensity of at least about 3.4 on a scale of 1-5.

27. The comestible of claim 26, wherein said sweetening composition is present in amounts of about 1% to about 99.5% by weight of said comestible.

28. The comestible of claim 26, wherein said food-grade acid composition is present in amounts of about 0.01% to about 20% by weight of said comestible.

29. The comestible of claim 26, wherein said cooling agent is present in amounts of about 0.001% to about 1.5% by weight of said comestible.

30. A comestible comprising:
(a) a composition comprising a blend of:
(i) a sweetening composition comprising sugar and a sweetness reducing agent;
(ii) a food-grade acid composition; and
(iii) optionally a cooling agent;
(b) a flavor agent; and
(c) optionally a carrier,
wherein said comestible has a mouth-watering effect of at least about 7 on a scale of 1-9.

31. The comestible of claim 30, wherein said sweetening composition is present in amounts of about 1% to about 99.5% by weight of said comestible.

32. The comestible of claim 30, wherein said food-grade acid composition is present in amounts of about 0.01% to about 20% by weight of said comestible.

33. The comestible of claim 30, wherein said cooling agent is present in amounts of about 0.001% to about 1.5% by weight of said comestible.

34. A chewable comestible comprising:
(a) a chewable carrier selected from the group consisting of water-soluble chewable bases, water insoluble chewable bases and combinations thereof;
(b) a composition comprising a blend of:
(i) a sweetening composition comprising sugar and a sweetness reducing agent;
(ii) a food-grade acid composition comprising malic acid; and
(iii) a cooling agent; and
(c) a flavor agent.

35. The comestible of claim 34, wherein said chewable carrier comprises a chewing gum base.

36. A method of improving the mouth-watering effect of a comestible, comprising the steps of:
(a) providing a comestible composition comprising a blend of:
(i) a food-grade acid composition comprising malic acid alone or in combination with one or more acids selected from the group consisting of acetic acid; adipic acid; ascorbic acid; butyric acid; citric acid; formic acid; fumaric acid; glyconic acid; lactic acid; phosphoric acid; oxalic acid; succinic acid; tartaric acid; and combinations thereof; and
(ii) a sweetening composition comprising sugar; and
(b) reducing the sweetness of the comestible composition by adding a sweetness reducing agent, wherein the sweetness reducing agent comprises about 0.05% to about 5% by weight of said sweetening composition.

37. The method of claim 36, wherein the comestible composition of step (a) further comprises a cooling agent.

38. A method of preparing a comestible, comprising the steps of:
(a) heating a sweetening composition comprising sugar and a sweetness reducing agent and a solvent to a temperature of about 135° C. to about 160° C.;
(b) adding to the heated sweetening composition:
(i) a food-grade acid composition comprising malic acid alone or in combination with one or more acids selected from the group consisting of acetic acid; adipic acid; ascorbic acid; butyric acid; citric acid; formic acid; fumaric acid; glyconic acid; lactic acid; phosphoric acid; oxalic acid; succinic acid; tartaric acid; and combinations thereof;
(ii) optionally a cooling agent; and
(iii) a flavor agent; and
(c) forming a comestible from the combination of components.

39. The method of claim 38, wherein the step of forming a comestible comprises the steps of cooling the combination of components and cutting the cooled combination of components into a desired shape.

40. The method of claim 38, wherein the step of forming a comestible comprises the step of depositing the combination of components into a mold to form a comestible.

41. A method of treating xerostomia, comprising the steps of:
(a) providing a comestible comprising:
(i) a composition comprising a blend of a sweetening composition comprising sugar and a sweetness reducing agent, a food-grade acid composition comprising malic acid, and optionally a cooling agent;
(ii) a flavor agent; and
(iii) optionally a carrier;
(b) applying the comestible into the oral cavity of an individual; and
(c) allowing the comestible to dissolve and release the composition of step (a) from the comestible into the oral cavity, thereby reducing the mouth dryness of the individual.

42. A center-fill confectionery composition comprising:
(a) a center-fill region; and
(b) a confectionery region surrounding said center-fill region, said confectionery region comprising a carrier,
wherein at least one of said regions comprises a mouth-moistening composition comprising:
(i) a sweetening composition comprising sugar and a sweetness reducing agent; and
(ii) a food-grade acid composition.

43. The confectionery composition of claim 42, wherein said center-fill region comprises a powdered center-fill composition.

44. The confectionery composition of claim 42, wherein said mouth-moistening composition is present in said center-fill region.

45. The confectionery composition of claim 42, wherein said mouth-moistening composition is present in said confectionery region.

46. The confectionery composition of claim 42, wherein said center-fill region comprises a first mouth-moistening composition and said confectionery region comprises a second mouth-moistening composition.

47. The confectionery composition of claim 46, wherein said first and said second mouth-moistening compositions are the same.

48. The confectionery composition of claim 46, wherein said first and said second mouth-moistening compositions are different.

49. The confectionery composition of claim 42, wherein said mouth-moistening composition further comprises a cooling agent.

50. A comestible comprising:
(a) a composition comprising a blend of:
(i) a sweetening composition comprising at least one non-sucrose saccharide, wherein said sweetening composition has a sweetness intensity less than the sweetness intensity of sucrose;
(ii) a food-grade acid composition; and
(iii) optionally a cooling agent;
(b) a flavor agent; and
(c) optionally a carrier.

51. The comestible of claim 50, wherein said sweetening composition is sugarless.

52. The comestible of claim 50, wherein said non-sucrose saccharide comprises a polyol selected from the group consisting of sorbitol, mannitol, maltitol, isomalt, polydextrose, xylitol, erythritol, lactitol, galactitol, hydrogenated starch hydrolysates, polyglycitol syrups, and combinations thereof.
